(19) United States
(12) Patent Application Publication
(10) Pub. No.: US 2012/0318473 A1
(43) Pub. Date: Dec. 20, 2012

(54) COOLING DEVICE FOR VEHICLE

(75) Inventors: Michio Nishikawa, Nagoya-city (JP); Nobuharu Kakehashi, Toyoake-city (JP)

(73) Assignee: DENSO CORPORATION, Kariya-city (JP)

(21) Appl. No.: 13/495,074

(22) Filed: Jun. 13, 2012

(30) Foreign Application Priority Data
Jun. 17, 2011 (JP) 2011-135470

(51) Int. Cl. B60H 1/32

(52) U.S. Cl. 165/41

(57) ABSTRACT

A cooling device for a vehicle includes a first radiator and a second radiator. The first radiator includes first tubes through which first coolant flows, and the second radiator includes second tubes through which second coolant flows. The second radiator is arranged downstream of the first radiator in a flow direction of cooling air, and the second tubes are elongated in a longitudinal direction different from a longitudinal direction of the first tubes. The second radiator is configured to cause a flow amount of the second coolant flowing respectively in the second tubes to be gradually increased with respect to a flow direction of the first coolant flowing in the first tubes.

### CROSS REFERENCE TO RELATED APPLICATION

This application is based on and incorporates herein by reference Japanese Patent Application No. 2011-135470 filed on Jun. 17, 2011.

### TECHNICAL FIELD

The present disclosure relates to a cooling device for a vehicle, which includes two radiators arranged in a flow direction of cooling air,

### BACKGROUND

Conventionally, a heat exchange device for a vehicle, described in Patent Document 1 (JP 9-030246A), is known. The heat exchange device includes a cooling fan which blows cooling air, a radiator arranged upstream of the cooling fan in a flow direction of the cooling air to cool coolant of an engine, and a condenser arranged upstream of the radiator in the flow direction of the cooling air to cool refrigerant of an air-conditioning refrigerant cycle. The condenser has a core part (refrigerant tube part) and a pair of header tanks, and the core part and at least one of the two header tanks are located in a region of a core part (coolant tube part) of the radiator, when viewed from the flow direction of the cooling air direction.

During the cooling of refrigerant in the condenser described in the Patent Document 1, the refrigerant changes in its phase state from a gas state to a liquid state. Thus, a temperature of the refrigerant is approximately uniform in a flow direction of the refrigerant in the core part (refrigerant tube part) of the condenser. Therefore, cooling air flowing out of the core part of the condenser has approximately a uniform temperature distribution in the flow direction of the refrigerant.

When another radiator (first radiator) which cools a heat generator different from the engine by using low-temperature coolant lower than the engine coolant in temperature is arranged upstream of the radiator (second radiator) instead of the condenser, and when the low-temperature coolant does not change its state (liquid state) in, the first radiator, a temperature of the cooling air may become uneven in a flow direction of the low-temperature coolant.

Accordingly, cooling air having an uneven temperature distribution is supplied to the core part of the second radiator, and a cooling performance in the core part of the second radiator cannot be thereby improved sufficiently.

### SUMMARY

It is an object of the present disclosure to provide a cooling device for a vehicle, which has two radiators arranged in a flow direction of cooling air and is capable of improving a cooling performance thereof.

According to an aspect of the present disclosure, a cooling device for a vehicle cools a first coolant circulating in a first heat generator in a liquid state, and cools a second coolant circulating in a second heat generator. The cooling device includes a first radiator and a second radiator. The first radiator includes a plurality of first tubes through which the first coolant flows, and the first radiator is configured to cool the first coolant via heat exchange with cooling air. The first tubes are arranged to have a laminated structure. The second radiator includes a plurality of second tubes through which the second coolant flows, and the second radiator is configured to cool the second coolant via heat exchange with the cooling air. The second tubes are arranged to have a laminated structure. The second radiator is arranged downstream of the first radiator in a flow direction of the cooling air to be overlapped with the first radiator in the flow direction of the cooling air. The second tubes are elongated in a longitudinal direction different from a longitudinal direction of the first tubes. The second radiator is configured to cause a flow amount of the second coolant flowing respectively in the second tubes to be gradually increased with respect to a flow direction of the first coolant flowing in the first tubes.

### BRIEF DESCRIPTION OF THE DRAWINGS

The disclosure, together with additional objectives, features and advantages thereof, will be best understood from the following description, the appended claims and the accompanying drawings in which:

FIG. 1 is a schematic front view showing a cooling device for a vehicle, according to a first embodiment of the present disclosure;

FIG. 2 is a schematic front view showing a rear radiator of the cooling device according to the first embodiment;

FIG. 3 is a diagram showing a temperature of air at an air outlet of a front radiator of the cooling device, and showing a flow amount of coolant in the rear radiator, according to the first embodiment;

FIG. 4 is a diagram showing a cooling performance improvement rate in the cooling device according to the first embodiment;

FIG. 5 is a schematic front view showing a rear radiator of a cooling device for a vehicle, according to a second embodiment of the present disclosure;

FIG. 6 is a schematic front view showing a rear radiator of a cooling device for a vehicle, according to a third embodiment of the present disclosure;

FIG. 7 is a schematic front view showing a rear radiator of a cooling device for a vehicle, according to a fourth embodiment of the present disclosure;

FIG. 8 is a schematic sectional view showing an inlet-side tank of a rear radiator of a cooling device for a vehicle, according to a fifth embodiment of the present disclosure;

FIG. 9 is a schematic sectional view showing an inlet-side tank of a rear radiator of a cooling device for a vehicle, according to a sixth embodiment of the present disclosure;

FIG. 10 is a schematic sectional view showing an inlet-side tank of a rear radiator of a cooling device for a vehicle, according to a seventh embodiment of the present disclosure;

FIG, 11 is a schematic sectional view showing an inlet-side tank of a rear radiator of a cooling device for a vehicle, according to an eighth embodiment of the present disclosure;

FIG. 12 is a schematic front view showing a cooling device for a vehicle, according to a ninth embodiment of the present disclosure; and

FIG. 13 is a diagram showing a cooling performance improvement rate in the cooling device according to the ninth embodiment.

### DETAILED DESCRIPTION

Embodiments of the present disclosure will be described hereinafter referring to drawings. In the embodiments, a part that corresponds to a matter described in a preceding embodiment may be assigned the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

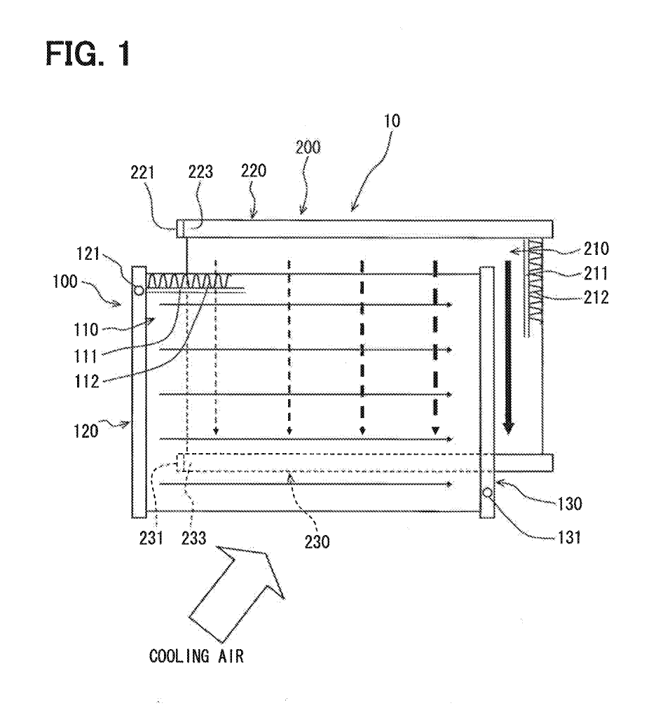

A cooling device 10 for a vehicle, according to a first embodiment, will be described in reference to FIGS. 1 to 4.

The vehicle cooling device 10 cools multiple heat generators installed in an electrical vehicle (EV) such as a fuel-cell vehicle, for example. A first heat generator in the multiple heat generators is, for example, an EV device, which includes a motor for vehicle running and an inverter controlling an operation of the motor. A second heat generator in the multiple heat generators is, for example, a fuel cell which supplies electric power to the motor.

The EV device has an EV-device coolant circuit in which first coolant circulates. In the EV-device coolant circuit, a first radiator 100 is disposed to cool the first coolant. The first coolant is adjusted at about 65° C. in temperature by an operation of the first radiator 100. The first coolant is cooled in the first radiator 100 in a liquid state of the first coolant. In other words, the first coolant does not change its phase state from a gas state to the liquid state during flowing in the first radiator 100, unlike refrigerant cooled in a condenser of an air-conditioning refrigerant cycle, for example.

The fuel cell has a fuel-cell coolant circuit in which second coolant circulates. In the fuel-cell coolant circuit, a second radiator 200 is disposed to cool the second coolant. The second coolant is adjusted in a temperature range from 60 to 95° C. by an operation of the second radiator 200.

The EV device is smaller than the fuel cell in heat generation amount, and a flow amount of the first coolant flowing in the first radiator 100 is set to be smaller than a flow amount of the second coolant flowing in the second radiator 200. For example, the flow amount of the first coolant in the first radiator 100 is about 15 L/min, and the flow amount of the second coolant in the second radiator 200 is from 100 to 200 L/min.

As shown in FIG. 1, the vehicle cooling device 10 includes the first radiator 100 and the second radiator 200. The first radiator 100 is disposed rearward of a grill in an engine compartment of the vehicle in a front-rear direction of the vehicle, and the second radiator 200 is disposed rearward of the first radiator 100 so that the first radiator 100 and the second radiator 200 are overlapped each other in the front-rear direction of the vehicle. In other words, the first radiator 100 and the second radiator 200 are arranged in the vehicle front-rear direction in this order. Hereinafter, the first radiator 100 and the second radiator 200 are referred to as a front radiator 100 and a rear radiator 200, respectively.

A not-shown electrical fan is provided rearward of the rear radiator 200 to supply cooing air to core parts 110, 210 of the front and rear radiators 100, 200 from a front side to a rear side of the vehicle. In other words, the cooling air supplied to the front radiator 100 and the rear radiator 200 in this order.

The front radiator 100 includes the core part 110, an inlet-side tank 120 and an outlet-side tank 130. The core part 110 is a heat exchange portion, and includes first tubes 111 and fins 112. Components of the front radiator 100 are made of aluminum or aluminum alloy, for example. The front radiator 100 is obtained in following steps, for example. That is, (i) the components of the front radiator 100 are assembled temporarily; (ii) the assembled components are heated in a furnace; and (iii) the components are brazed integrally.

Each of the first tubes 111 is a pipe member having a flat shape in cross-section, and the first coolant flows through insides of the first tubes 111. The first tubes 111 have a laminated structure such that major sides of the flat cross-sectional shapes of adjacent two first tubes 111 are opposed to each other. The first tubes 111 are arranged so that a longitudinal direction thereof is parallel to a horizontal direction, and a laminated direction (arrangement direction) of the first tubes 111 is parallel to a vertical direction. For example, the first tubes 111 are formed by bending a plate member and joining end portions of the bended plate member, or by extrusion processing or the like.

The fins 112 are heat-transfer portions, and are interposed between the first tubes 111 to expand a heat-transfer area with the cooling air. Each of the fins 112 is made from, for example, a corrugated fin obtained by rolling a plate member, and peak parts of each corrugated fin 112 are brazed to the first tubes 111.

The inlet-side tank 120 introduces thereinto the first coolant flowing from the EV-device coolant circuit, and distributes the first coolant to the first tubes 111. The inlet-side tank 120 has a long and thin shape extending in the vertical direction parallel to the laminated direction of the first tubes 111. The inlet-side tank 120 has insertion holes at positions corresponding to one end sides (left sides in FIG. 1) of the first tubes 111 in the longitudinal direction of the first tubes 111. The one end sides of the first tubes 111 are inserted into the insertion holes of the inlet-side tank 120 respectively, and parts where the first tubes 111 and the insertion holes contact each other are brazed. An inside of the inlet-side tank 120 communicates with the insides of the first tubes 111. An upper part of the inlet-side tank 120 in a longitudinal direction thereof has an inlet portion 121 through which the first coolant is introduced into the inlet-side tank 120.

The outlet-side tank 130 receives and corrects the first coolant flowing out of the first tubes 111. Similarly to the inlet-side tank 120, the outlet-side tank 130 has a long and thin shape extending in the vertical direction parallel to the laminated direction of the first tubes 111. The outlet-side tank 130 has insertion holes at positions corresponding to the other end sides (right sides in FIG. 1) of the first tubes 111. The other end sides of the first tubes 111 are inserted into the insertion holes of the outlet-side tank 130 respectively, and parts, where the first tubes 111 and the insertion holes contact each other, are brazed, so that an inside of the outlet-side tank 130 communicates with the insides of the first tubes 111. A lower part of the outlet-side tank 130 in a longitudinal direction thereof has an outlet portion 131 through which the first coolant flows out of the outlet-side tank 130 to outside (the EV-device coolant circuit).

In the front radiator 100, the first coolant flows into all of the one end sides of the first tubes 111 from the inlet-side tank 120, and flows through the first tubes 111 in the horizontal direction. Then, the first coolant flows out of the first tubes 111 through the other end sides of the first tubes 111 in the longitudinal direction thereof, and flows into, the outlet-side tank 130: Therefore, the front radiator 100 is used as a single-path cross-flow radiator.

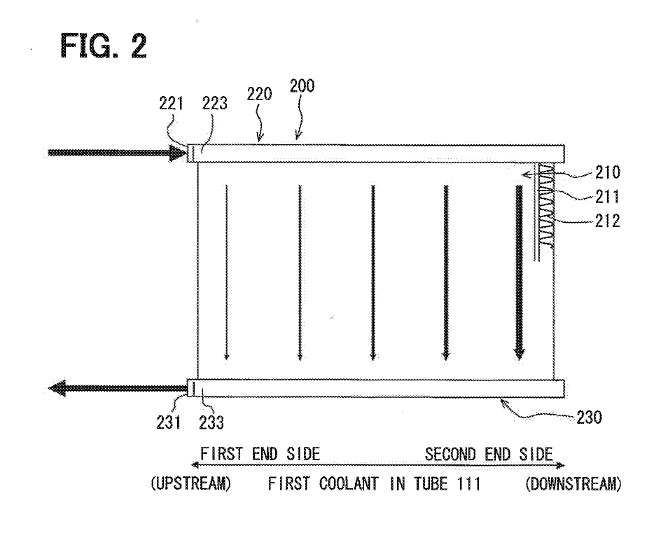

As shown in FIGS. 1 and 2, the rear radiator 200 has a similar structure of the front radiator 100, and includes the core part 210, an inlet-side tank 220 and an outlet-side tank 230. The core part 210 is a heat exchange portion, and includes second tubes 211 and fins 212. Components of the rear radiator 200 are made of aluminum or aluminum alloy, for example. The rear radiator 200 is obtained in following steps, for example. That is, (i) the components of the rear radiator 200 are assembled temporarily; (ii) the assembled components are heated in a furnace; and (iii) the components are brazed integrally.

Each of the second tubes 211 is a pipe member having a flat shape in cross-section, and the second coolant flows through insides of the second tubes 211. The second tubes 211 have a laminated structure such that major sides of the flat cross-sectional shapes of adjacent two second tubes 211 are opposed to each other. The second tubes 211 are arranged so that a longitudinal direction thereof is parallel to the vertical direction, and a laminated direction (arrangement direction) of the second tubes 211 is parallel to the horizontal direction. For example, the second tubes 211 are formed by bending a plate member and joining end portions of the bended plate member, or by extrusion processing or the like.

The fins 212 are heat-transfer portions, and each of the fins 212 is interposed between adjacent two second tubes 211 to expand a heat-transfer area with the cooling air. Each of the fins 212 is made from, for example, a corrugated fin obtained by rolling a plate member, and peak parts of each corrugated fin 212 are brazed to the second tubes 211.

The inlet-side tank 220 introduces the second coolant thereinto from the fuel-cell coolant circuit, and distributes the second coolant to the second tubes 211. The inlet-side tank 220 has a long and thin shape extending in the horizontal direction parallel to the laminated direction (arrangement direction) of the second tubes 211. The inlet-side tank 120 has insertion holes at positions corresponding to one end sides (upper sides in FIGS. 1 and 2) of the second tubes 211. The one end sides of the second tubes 211 are inserted into the insertion holes of the inlet-side tank 220 respectively, and parts where the second tubes 211 and the insertion holes contact each other are brazed. An inside of the inlet-side tank 220 communicates with the insides of the second tubes 211.

The inlet-side tank 220 of the rear radiator 200 has two end portions in a longitudinal direction thereof. One end portion 223 of the inlet-side tank 220 of the rear radiator 200 is located at a first end side (left side in FIG. 2) corresponding to an upstream side in a flow direction of the first coolant flowing in the first tubes 111 of the first radiator 100. The other end portion of the inlet-side tank 220 of the rear radiator 200 is located at a second end side (right side in FIG. 2) corresponding to a downstream side in the flow direction of the first coolant flowing in the first tubes 111 of the first radiator 100. An inlet portion 221 is provided in the end portion 223 of the inlet-side tank 220 to introduce the second coolant into the inlet-side tank 220. Accordingly, in the rear radiator 200, as will be described in detail later, the flow amount of the second coolant can be made larger in the second tubes 211 at the second end side (right side in FIG. 2) corresponding to the downstream side in the flow direction of the first coolant flowing in the first tubes 111 of the first radiator 100, than at the first end side (left side in FIG. 2) corresponding to the upstream side in the flow direction of the first coolant flowing in the first tubes 111 of the first radiator 100.

The outlet-side tank 230 receives the second coolant flowing out of the second tubes 211. Similarly to the inlet-side tank 220, the outlet-side tank 230 has a long and thin shape extending in the horizontal direction parallel to the laminated direction (arrangement direction) of the second tubes 211. The outlet-side tank 230 has insertion holes at positions corresponding to the other end sides (lower sides in FIGS. 1 and 2) of the second tubes 211. The other end sides of the second tubes 211 are inserted into the insertion holes of the outlet-side tank 230 respectively, and parts, where the second tubes 211 and the insertion holes contact with each other, are brazed, so that an inside of the outlet-side tank 230 communicates with the insides of the second tubes 211. The outlet-side tank 230 has two end portions in a longitudinal direction thereof. One end portion 233 of the outlet-side tank 230 of the rear radiator 200 is located at the first end side (left side in FIG. 2) corresponding to the upstream side in the flow direction of the first coolant flowing in the first tubes 111 of the front radiator 100. The other end portion of the outlet-side tank 230 of the rear radiator 200 is located at the second end side (right side in FIG. 2) corresponding to the downstream side in the flow direction of the first coolant flowing in the first tubes 111 of the front radiator 100. An outlet portion 231 is provided in the end portion 233 of the outlet-side tank 230 to cause the second coolant to flow out of the outlet-side tank 230 to outside (fuel-cell coolant circuit) through the outlet portion 231.

In the rear radiator 200, the second coolant flows from the inlet-side tank 220 into all of the one end sides of the second tubes 211 in the longitudinal direction of the second tubes 211, and flows through the second tubes 211 in the longitudinal direction corresponding to the vertical direction. Then, the second coolant flows out of the second tubes 211 through the other end sides of the second tubes 211 in the longitudinal direction of the second tubes 211, and flows into the outlet-side tank 230. Therefore, the rear radiator 200 is used as a single-path down-flow radiator.

An operation of the vehicle cooling device 10 having the above-described configuration will be described in reference to FIGS. 1 to 4.

In the front radiator 100, the first coolant in the EV-device coolant circuit flows into the inlet-side tank 120 through the inlet portion 121, and then flows through the first tubes 111. Subsequently, the first coolant is stored in the outlet-side tank 130, and flows out of the outlet-side tank 130 through the outlet portion 131 to be returned to the EV-device coolant circuit. As described above, cooling air is supplied to the core part 110 by the electrical fan, and the first coolant flowing through the first tubes 111 is cooled to a predetermined first coolant temperature (about 65° C.) via heat exchange with the cooling air.

In the rear radiator 200, the second coolant in the fuel-cell coolant circuit flows into the inlet-side tank 220 through the inlet portion 221, and then flows through the second tubes 211. Subsequently, the second coolant is stored in the outlet-side tank 230, and flows out of the outlet-side tank 230 through the outlet portion 231 to be returned to the fuel-cell coolant circuit. As described above, cooling air is supplied to the core part 210 by the electrical fan, and the second coolant flowing through the second tubes 211 is cooled to a predetermined second coolant temperature (from 60 to 95° C.) via heat exchange with the cooling air.

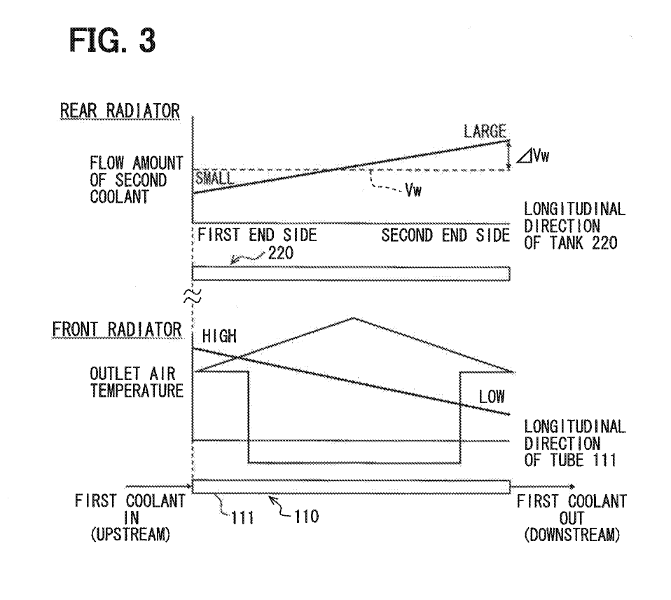

Because the first coolant is cooled in the liquid state of the first coolant without a phase change, a temperature of the first coolant decreases in accordance with positional shift from an upstream side to a downstream side of the first tubes 111 in the first-coolant flow, direction. Hence, in the front radiator 100, a temperature increase of the cooling air in heat exchange with the first coolant is reduced in accordance with the positional shift from the upstream side to the downstream side of the first tubes 111 in the first-coolant flow direction. Therefore, as shown in FIG. 3, the cooling air flowing out of the front radiator 100, i.e., the cooling air flowing at an air outlet of the front radiator 100 has a temperature distribution, in which a temperature of the cooling air flowing at the air outlet of the front radiator 100 gradually decreases in the first-coolant flow direction.

Because the rear radiator 200 is arranged downstream of the front radiator 100 in a flow direction of the cooling air, the cooling air having the above-described temperature distribution flows into the rear radiator 200. Here, the longitudinal direction of the second tubes 211 is set to be different from the longitudinal direction of the first tubes 111. Moreover, as shown in FIGS. 1 to 3, in the rear radiator 200, a flow amount of the second coolant flowing in the second tubes 211 is set to be gradually increased from the first end side to the second end side. That is, the flow amount of the second coolant flowing in the second tubes 211 is gradually increased with respect to the flow direction of the first coolant flowing in the first tubes 111.

In the present embodiment, the flow amount of the second coolant is larger in the second tubes 211 on the second end side corresponding to the downstream side in the flow direction of the first coolant flowing in the first tubes 111, than on the first end side corresponding to the upstream side in the first-coolant flow direction. The second coolant introduced into the inlet-side tank 220 through the inlet portion 221 flows from the end portion 223 to the other end portion of the inlet-side tank 220 in the longitudinal direction thereof by using a dynamic pressure of the second coolant itself. Thus, the flow amount of the second coolant from the inlet-side tank 220 to the second tubes 211 can be gradually increased with respect to the flow direction of the first coolant flowing in the first tubes 111. As shown in FIG. 3, an average flow amount (entire flow amount/the number of the second tubes 211) of the second coolant flowing in the second tubes 211 is defined as Vw, and a largest increased amount of the second coolant in the second end side of the second tubes 211 corresponding to the downstream side in the first-coolant flow direction, is defined as ΔVw. The flow amount of the second coolant flowing in the second tubes 211 on the first end side corresponding to the upstream side in the first-coolant flow direction, is smaller than the average flow amount Vw.

Because cooling air having a relatively low temperature passes through the second tube 211 on the second end side in which the flow amount of the second coolant is set to be relatively large, the cooling air having the relatively low temperature can thereby cool a large amount of the second coolant. Hence, a cooling performance in the rear radiator 200 can be improved as compared to a case in which the second coolant flows in the second tubes 211 uniformly.

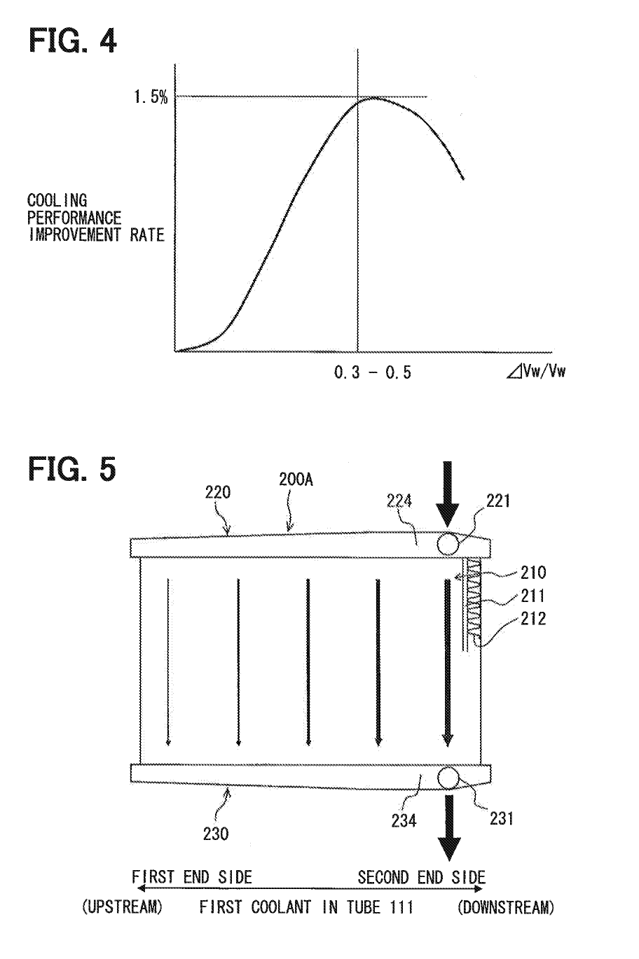

As shown in FIG. 4, a ratio of a largest flow amount (Vw+ΔVw) of the second coolant to the average flow amount Vw of the second coolant flowing in the second tubes 211 may be set to be from 1.3 to 1.5. In this case, the cooling performance in the rear radiator 200 can be improved by largest amount, e.g., by approximately 1.5%.

The flow amount of the first coolant flowing in the front radiator 100 is set to be smaller than the flow amount of the second coolant flowing in the rear radiator 200, and a flow amount of cooling air which cools the first coolant is equivalent to a flow amount of cooling air which cools the second coolant. Hence, a decreased degree of a temperature of the first coolant in heat exchange with cooling air in the front radiator 100 is higher than a decreased degree of a temperature of the second coolant in heat exchange with cooling air in the rear radiator 200. In this case, a temperature difference of the cooling air, between flowing out of an upstream part of the front radiator 100 in the first-coolant flow direction and flowing out of a downstream part of the front radiator 100 in the first-coolant flow direction, becomes large. In this case, the large temperature difference of the cooling air is generated in the front radiator 100. However, because the flow amount of the second coolant in the second tubes 211 of the rear radiator 200 is set to be gradually increased in the first-coolant flow direction, the cooling performance in the rear radiator 200 can be thereby more improved.

A temperature of the first coolant in the front radiator 100 is set to be lower than a temperature of the second coolant in the rear radiator 200. Accordingly, a temperature difference between cooling air flowing into the front radiator 100 and the first coolant, and a temperature difference between cooling air flowing into the rear radiator 200 and the second coolant can be ensured in a balanced manner, respectively. Therefore, cooling performances in both the front and rear radiators 100 and 200 can be improved. As a result, a cooling performance in the vehicle cooling device 10 can be improved as a whole. The flow amount of the first coolant flowing in the front radiator 100 is set to be smaller than the flow amount of the second coolant flowing in the rear radiator 200. Moreover, the front radiator 100 is used as the single-path cross-flow radiator, and the rear radiator 200 is used as the single-path down-flow radiator. Thus, the number of the first tubes 111 may be reduced, and lengths of the first tubes 111 may be lengthened in the front radiator 100. Even when the flow amount of the first coolant is small, the cooling performance in the front radiator 100 can be improved by increasing a flow rate of the first coolant without being greatly affected by increase of flow resistance.

### Second Embodiment

A rear radiator 200A of a second embodiment will be described referring to FIG. 5. In the second embodiment, positions of the inlet portion 221 and the outlet portion 231 described in the above first embodiment are changed in the inlet-side tank 220 and the outlet-side tank 230.

The inlet-side tank 220 has a side surface portion 224 on a side surface of the inlet-side tank 220 parallel to the plane of the paper of FIG. 5. In other words, the side surface portion 224 is provided on the surface of the inlet-side tank 220 parallel to the longitudinal direction of the inlet-side tank 220 and to the longitudinal direction of the second tubes 211. As shown in FIG. 5, the inlet portion 221 is provided in the side surface portion 224 at a second end side corresponding to a downstream side in the flow direction of the first coolant flowing in the first tubes 111. The outlet-side tank 230 has a side surface portion 234 on a side surface of the outlet-side tank 230 parallel to the plane of the paper of FIG. 5. In other words, the side surface portion 234 is provided on the surface of the outlet-side tank 230 parallel to the longitudinal direction of the outlet-side tank 230 and to the longitudinal direction of the second tubes 211. As shown in FIG. 5, the outlet portion 231 is provided in the side surface portion 234 at the second end side corresponding to the downstream side in the first-coolant flow direction.

In the present embodiment, the second coolant flows into the inlet-side tank 220 through the inlet portion 221, and flows through the second tubes 211. Subsequently, the second coolant flows into the outlet-side tank 230, and flows out of the outlet-side tank 230 through the outlet portion 231. In the present embodiment, a large amount of the second coolant tends to flow through a part of the second tubes 211 near the inlet portion 221 and the outlet portion 231 which are positioned on the second end side. Thus, the flow amount of the second coolant in the second tubes 211 can be gradually increased with respect to the flow direction of the first coolant flowing in the first tubes 111. Therefore, a similar effect to the first embodiment can be obtained in the second embodiment.

The position of the outlet portion 231 is not limited to the above-described position in the longitudinal direction of the outlet-side tank 230, and the outlet portion 231 may be arranged in an arbitrary position of the side surface potion 234 in the longitudinal direction of the outlet-side tank 230.

The side surface portions 224, 234, in which the inlet portion 221 and the outlet portion 231 are arranged respectively, are provided on the surfaces of the tanks 220, 230 parallel to the plane of the paper of FIG. 5, respectively. In other words, the side surface portions 224 and 234 are provided on the side surfaces of the inlet-side tank 220 and the outlet-side tank 230, respectively. However, the side surface portions 224 and 234 may be provided on a surface intersecting the plane of the paper of FIG. 5, e.g., on top surfaces or on bottom surfaces of the tanks 220, 230.

### Third Embodiment

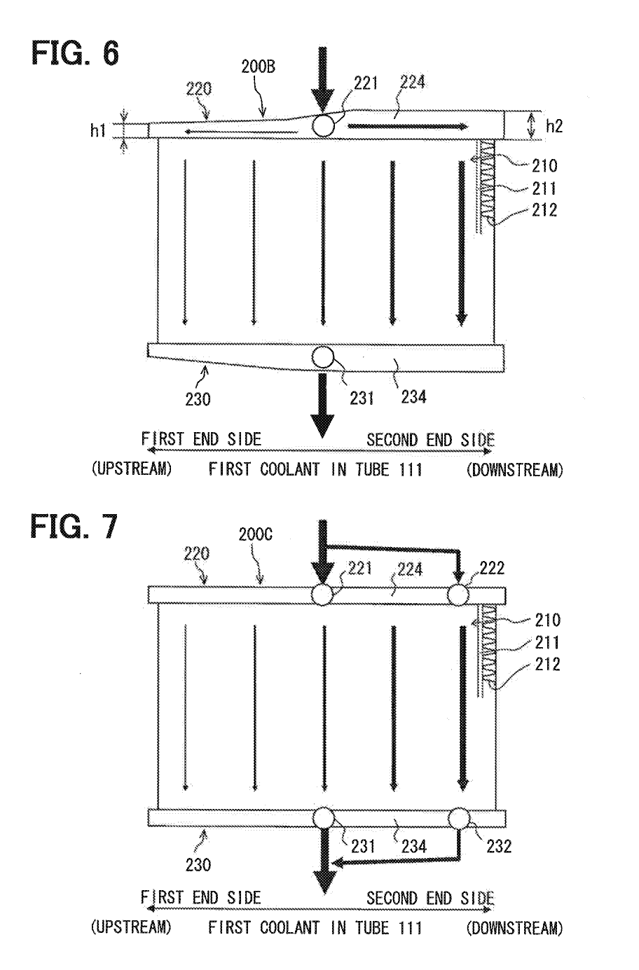

A rear radiator 200B of a third embodiment will be described referring to FIG. 6. In the third embodiment, a shape of the inlet-side tank 220 is changed, and positions of the inlet portion 221 and the outlet portion 231 are changed, as compared to the first embodiment.

The inlet-side tank 220 has therein a flow passage through which the second coolant flows, and the flow passage has an unequal cross-section in the longitudinal direction of the inlet-side tank 220. For example, as shown in FIG. 6, a height dimension of the inlet-side tank 220 parallel to the longitudinal direction of the second tubes 211 is gradually increased from h1 to h2, with respect to the flow direction of the first coolant flowing in the first tubes 111. In other words, the cross-section of the flow passage of the inlet-side tank 220 is gradually increased from the first end side corresponding to the upstream side in the flow direction of the first coolant flowing in the first tubes 111, to the second end side corresponding to the downstream side in the flow direction of the first coolant flowing in the first tubes 111. Accordingly, a flow resistance in the inlet-side tank 220 against the second coolant is gradually reduced in the first-coolant flow direction.

The inlet portion 221 is provided approximately at a center of the side surface portion 224 of the inlet-side tank 220 in the longitudinal direction of the inlet-side tank 220. The outlet portion 231 is provided approximately in a center of the side surface portion 234 of the outlet-side tank 230 in the longitudinal direction of the outlet-side tank 230.

In the present embodiment, the second coolant introduced into the inlet-side tank 220 through the inlet portion 221 tends to flow through a part of the inlet-side tank 220 having a relatively low flow resistance. Hence, in the second tubes 211, the flow amount of the second coolant can be increased, in the flow direction of the first coolant flowing in the first tubes 111. Therefore, a similar effect to the first embodiment can be obtained in the third embodiment.

The side surface portions 224, 234, in which the inlet portion 221 and the outlet portion 231 are arranged respectively, are provided on the surfaces of the tanks 220, 230 parallel to the plane of the paper of FIG. 6, respectively. In other words, the side surface portions 224 and 234 are provided on the side surfaces of the inlet-side tank 220 and the outlet-side tank 230, respectively. However, the side surface portions 224 and 234 may be provided on a surface intersecting the plane of the paper of FIG. 6, e.g., on top surfaces or on bottom surfaces of the tanks 220, 230.

### Fourth Embodiment

A rear radiator 200C of a fourth embodiment will be described referring to FIG. 7. In the fourth embodiment, positions of the inlet portion 221 and the outlet portion 231 are changed, and an inlet portion 222 and an outlet portion 232 are provided in addition, as compared to the first embodiment.

The inlet portion 221 is provided approximately at the center of the side surface portion 224 of the inlet-side tank 220 in the longitudinal direction of the inlet-side tank 220. The outlet portion 231 is provided approximately at the center of the side surface portion 234 of the outlet-side tank 230 in the longitudinal direction of the outlet-side tank 230.

Additionally, the inlet portion 222 as a second inlet portion is provided in the side surface portion 224 of the inlet-side tank 220 at the second end side corresponding to the downstream side in the flow direction of the first coolant flowing in the first tubes 111. Moreover, the outlet portion 232 as a second outlet portion is provided in the side surface portion 234 of the outlet-side tank 230 at the second end side corresponding to the downstream side in the flow direction of the first coolant flowing in the first tubes 111.

In the present embodiment, the second coolant flows into the inlet-side tank 220 through both the inlet portion 221 and the second inlet portion 222, and the second coolant flows out of the outlet-side tank 230 through both the outlet portion 231 and the second outlet portion 232. Because of the second inlet portion 222 and of the second outlet portion 232, the flow amount of the second coolant in the second tubes 211 can be gradually increased, in the flow direction of the first coolant flowing in the first tubes 211. Therefore, a similar effect to the first embodiment can be obtained in the fourth embodiment.

The setting of the second outlet portion 232 is not limited to the setting described above, and the second outlet portion 232 may be omitted.

The side surface portion 224, in which the inlet portions 221, 222 are provided, and the side surface portion 234, in which the outlet portions 231, 232 are provided, are provided on a surface parallel to the plane of the paper of FIG. 7. In other words, the side surface portions 224 and 234 are provided in the side surfaces of the inlet-side tank 220 and the outlet-side tank 230, respectively. However, the side surface portions 224 and 234 may be provided in a surface intersecting the plane of the paper of FIG. 7, e.g., on the top surfaces and on the bottom surfaces of the tanks 220, 230, respectively.

### Fifth Embodiment

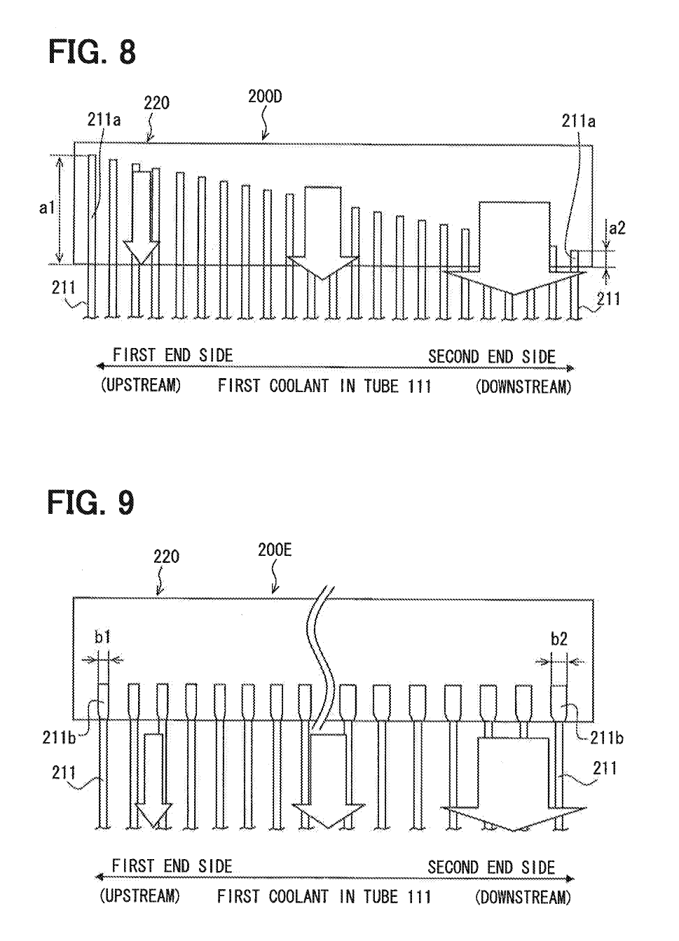

A rear radiator 200D of a fifth embodiment will be described referring to FIG. 8. In the fifth embodiment, inserted lengths of the second tubes 211 into the inlet-side tank 220 are changed, as compared to the first embodiment.

The one end sides of the second tubes 211 are inserted into the inlet-side tank 220 to be connected (brazed) to the inlet-side tank 220. Here, the portions of the second tubes 211 inserted into the inlet-side tank 220 are referred to as inserted portions 211a. A length of each inserted portion 211a in the longitudinal direction of the second tubes 211 is defined as an insertion dimension, and the insertion dimension of the second tube 211 is gradually decreased from a1 to a2 with respect to the flow direction of the first coolant flowing in the first tubes 111, as shown in FIG. 8. In other words, a protrusion length of the second tube 211 in the inlet-side tank 220 is gradually decreased from the first end side corresponding to the upstream side in the flow direction of the first coolant flowing in the first tubes 111, to the second end side corresponding to the downstream side in the flow direction of the first coolant flowing in the first tubes 111 in the flow direction of the first coolant flowing in the first tubes 111. Accordingly, the flow resistance in the inlet-side tank 220 against the second coolant is gradually decreased in the first-coolant flow direction.

In this case, the position of the inlet portion 221 of the inlet-side tank 220 and the position of the outlet portion 231 of the outlet-side tank 230 are not limited specifically in the longitudinal directions of the tanks 220 and 230, respectively.

According to the present embodiment, in the inlet-side tank 220, a second tube 211 having a relatively large insertion dimension generally has a relatively high flow resistance against the second coolant. Thus, the second coolant is likely to flow into a second tube 211 having a relatively small insertion dimension. Hence, the flow amount of the second coolant in the second tubes 211 can be gradually increased in the flow direction of the first coolant flowing in the first tubes 111. Therefore, a similar effect to the first embodiment can be obtained in the fifth embodiment.

The insertion dimension of the second tube 211 may be set to be gradually decreased in the first-coolant flow direction continuously one by one. Alternatively, the second tubes 211 may be separated into plural groups having a predetermined number of the second tubes 211, and the insertion dimension of the second tube 211 may be set to be gradually decreased in the plural groups in the first-coolant flow direction. In this case, in each group, the insertion dimension of the second tube 211 may be set to be equal.

### Sixth Embodiment

A rear radiator 200E of a sixth embodiment will be described referring to FIG. 9. In the sixth embodiment, the second tubes 211 have expanded portions 211b in the inlet-side tank 220, and expansion dimensions of the expanded portions are changed, as compared to the first embodiment.

The expanded portions 211b of the second tubes 211 are obtained by expanding cross-sections of the one end sides of the second tubes 211 in the longitudinal direction thereof inserted into the inlet-side tank 220 through the insertion holes. Because of the expanded portions 211b, a degree of contact between the second tubes 211 and the insertion holes is improved, and an ease of braze therebetween is also improved. A dimension of each of the expanded portions 211b in a laminated direction of the second tubes 211 is referred to as an expansion dimension, and the expansion dimension of the second tube 211 is gradually increased from b1 to b2 in the flow direction of the first coolant flowing in the first tubes 111, as shown in FIG. 9. In other words, a cross-section of a portion of the second tube 211, into which the second coolant flows, is gradually increased from the first end side corresponding to the upstream side in the flow direction of the first coolant flowing in the first tubes 111, to the second end side corresponding to the downstream side in the flow direction of the first coolant flowing in the first tubes 111. Therefore, a flow resistance generated when the second coolant flows into the second tubes 211 can be gradually decreased in the first-coolant flow direction.

In this case, the position of the inlet portion 221 of the inlet-side tank 220 and the position of the outlet portion 231 of the outlet-side tank 230 are not limited specifically in the longitudinal directions of the tanks 220 and 230, respectively.

According to the present embodiment, in the inlet-side tank 220, the second coolant tends to flow into a second tube 211 having a large expansion dimension. Thus, in the second tubes 211, the flow amount of the second coolant can be increased in the flow direction of the first coolant flowing in the first tubes 111. Therefore, a similar effect to the first embodiment can be obtained in the sixth embodiment.

The expansion dimension of the second tube 211 may be set to be gradually increased in the first-coolant flow direction continuously one by one. Alternatively, the second tubes 211 may be separated into plural groups having a predetermined number of the second tubes 211, and the expansion dimension of the second tube 211 may be set to be gradually increased in the plural groups in the first-coolant flow direction. In this case, in each group, the expansion dimension of the second tube 211 may be set to be equal.

### Seventh Embodiment

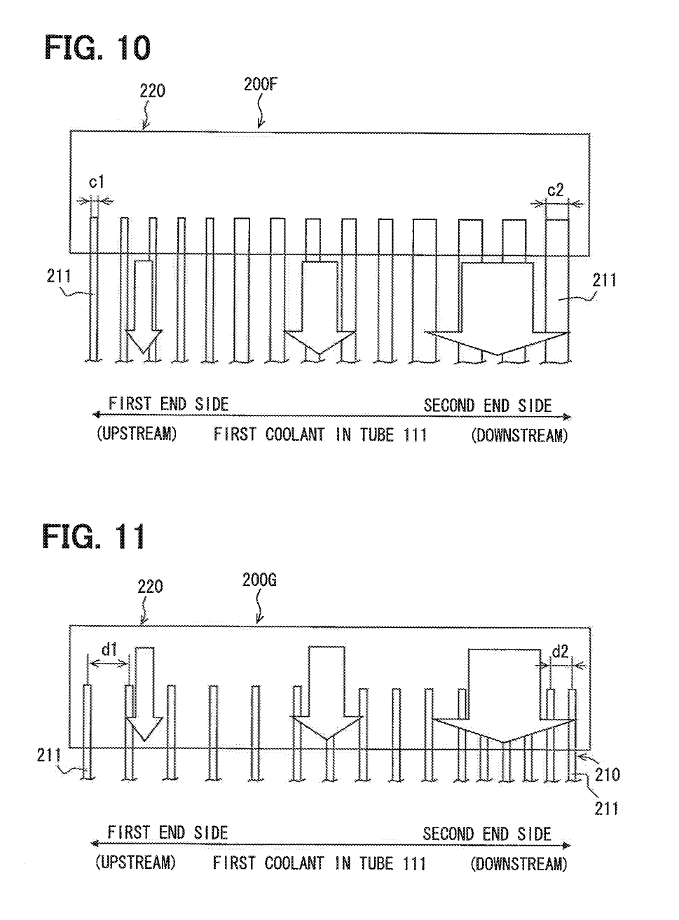

A rear radiator 200F of a seventh embodiment will be described referring to FIG. 10. In the seventh embodiment, a width dimension of the second tube 211 is changed, as compared to the first embodiment.

A dimension of the second tube 211 in the laminated direction of the second tubes 211 is referred to as a width dimension, and the width dimension of the second tube 211 is gradually increased from c1 to c2 in the flow direction of the first coolant flowing in the first tubes 111, as shown in FIG. 10. In other words, a cross-section of the second tube 211 is gradually increased from the first end side corresponding to the upstream side in the flow direction of the first coolant flowing in the first tubes 111, to the second end side corresponding to the downstream side in the flow direction of the first coolant flowing in the first tubes 111. Therefore, a flow resistance generated when the second coolant passes through the second tube 211 can be gradually decreased in the first-coolant flow direction.

In this case, the position of the inlet portion 221 of the inlet-side tank 220 and the position of the outlet portion 231 of the outlet-side tank 230 are not limited specifically in the longitudinal directions of the tanks 220 and 230, respectively.

According to the present embodiment, in the inlet-side tank 220, the second coolant tends to flow into and through a second tube having a relatively large cross-section. Thus, the flow amount of the second coolant in the second tube 211 can be increased in the flow direction of the first coolant flowing in the first tubes 111. Therefore, a similar effect to the first embodiment can be obtained in the seventh embodiment.

The width dimension of the second tube 211 may be set to be gradually increased in the first-coolant flow direction continuously one by one. Alternatively, the second tubes 211 may be separated into plural groups having a predetermined number of the second tubes 211, and the width dimension of the second tube 211 may be set to be gradually increased in the plural groups in the first-coolant flow direction. In this case, in each group, the width dimension of the second tube 211 may be set to be equal.

### Eighth Embodiment

A rear radiator 200G of an eighth embodiment will be described referring to FIG. 11. In the eighth embodiment, a gap between adjacent two second tubes 211 is changed, as compared to the first embodiment.

A gap between adjacent two second tubes 211 in the laminated direction of the second tubes 211 is referred to as an inter-tube dimension, and the inter-tube dimension is gradually reduced from d1 to d2 in the flow direction of the first coolant flowing in the first tubes 111, as shown in FIG. 11. In other words, adjacent second tubes 211 are arranged so as to become closer in the second tubes 211 at the second end side corresponding to the downstream side in the flow direction of the first coolant flowing in the first tubes 111, than at the first end side corresponding to the upstream end side in the flow direction of the first coolant flowing in the first tubes 111.

In this case, the position of the inlet portion 221 of the inlet-side tank 220 and the position of the outlet portion 231 of the outlet-side tank 230 are not limited specifically in the longitudinal directions of the tanks 220 and 230, respectively.

In the present embodiment, a relatively large amount of the second coolant generally flows through a region of the second tubes 211 in which the inter-tube dimension is relatively small. Thus, the flow amount of the second coolant in the second tubes 211 can be gradually increased in the flow direction of the first coolant flowing in the first tubes 111. Therefore, a similar effect to the first embodiment can be obtained in the eighth embodiment.

The inter-tube dimension of the second tube 211 may be set to be gradually decreased in the first-coolant flow direction continuously one by one. Alternatively, the second tubes 211 may be separated into plural groups having a predetermined number of the second tubes 211, and the inter-tube dimension of the second tube 211 may be set to be gradually decreased in the plural groups in the first-coolant flow direction. In this case, in each group, the inter-tube dimension of the second tube 211 may be set to be equal.

### Ninth Embodiment

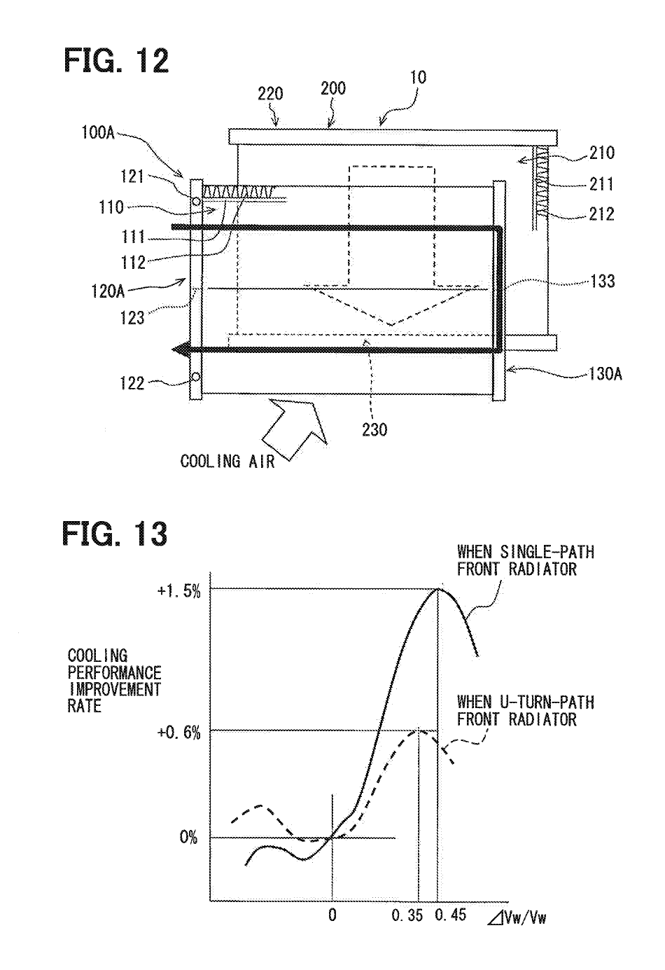

A vehicle cooling device 10 in a ninth embodiment will be described in reference to FIGS. 12 and 13. In the ninth embodiment, a structure of the rear radiator 200 is similar to that of the first embodiment, and a structure of a front radiator 100A is different from a structure of the front radiator 100 of the first embodiment.

The front radiator 100A includes a core part 110, a tank 120A and a tank 130A.

The tank 120A has a long and thin shape, similarly to the inlet-side tank 120 of the above-described first embodiment. A one-side end part (upper end part in FIG. 12) of the tank 120A in a longitudinal direction thereof has an inlet portion 121, and the other-side end part (lower end part in FIG. 12) of the tank 120A in the longitudinal direction has an outlet portion 122. Moreover, a division plate 123 is provided inside the tank 120A at a center part of the tank 120A in the longitudinal direction of the tank 120A to divide a space in the tank 120A into upper and lower spaces.

As shown in FIG. 12, a group of the first tubes 111, communicating with the upper space defined by the division plate 123 and the tank 120A, is referred to as a first group, and the other group of the first tubes 111, communicating with the lower space defined by the division plate 123 and the tank 120A, is referred to as a second group.

The tank 130A has a long and thin shape, similarly to the outlet-side tank 130 of the above-described first embodiment. A division plate 133, which divides a space in the tank 130A into upper and lower spaces, is provided inside the tank 130A at a center part of the tank 130A in the longitudinal direction of the tank 130A. The position of the division plate 133 corresponds to the position of the division plate 123 in the vertical direction. The division plate 133 has a hole through which the first coolant passes. The division plate 133 may be omitted.

First tubes 111 of the first group communicate with the upper space defined by the division plate 133 and the tank 130A. First tubes 111 of the second group communicate with the lower space defined by the division plate 133 and the tank 130A.

The front radiator 100A having the above-described configuration is used as a U-turn-path cross-flow radiator. In the front radiator 100A, the first coolant flows into the upper space of the tank 120A through the inlet portion 121, and flows in the horizontal direction through the first tubes 111 of the first group. Subsequently, a flow direction of the first coolant is reversed (U-turned) in the tank 130A, and then the first coolant flows in the horizontal direction through the first tubes 111 of the second group. And then, the first coolant flows out of the lower space of the tank 120A through the outlet portion 122.

In the present disclosure, a U-turn-path cross-flow radiator as described above may be used as the front radiator. In the U-turn-path cross-flow radiator 100A, the substantial number of the first tubes 111, through which the first coolant flows, can be reduced, and a flow rate of the first coolant can be increased. Therefore, the cooling performance can be improved.

In this case, as shown in FIG. 13, in the second tubes 211, a ratio of the largest flow amount (Vw+ΔVw) to the average flow amount Vw may be set to be about 1.35. In this case, the cooling performance in the rear radiator 200 can be improved about 0.6%.

Although the present disclosure has been fully described in connection with the preferred embodiments thereof with reference to the accompanying drawings, it is to be noted that various changes and modifications will become apparent to those skilled in the art.

In the above-described embodiments, the EV device is used as an example of the first heat generator, and the fuel cell is used as an example of the second heat generator, However, the first and second heat generators are not limited to these, and may be a variety of combinations. For example, in a hybrid vehicle, an EV device (a motor for vehicle running, an inverter) and an engine for vehicle running may be used as the first and second heat generators, respectively. Moreover, a buttery for power supply and an EV device (a motor for vehicle running, an inverter) may be used as the first and second heat generators, respectively. Additionally, an intake air supercharged by a supercharger and an engine for vehicle running may be used as the first and second generators, respectively.

The flow amount of the first coolant in the front radiator 100 is set to be smaller than the flow amount of the second coolant in the rear radiator 200 in the above-described embodiments. However, the magnitude relation of the flow amount between the first and second coolant may be reversed.

The temperature of the first coolant in the front radiator 100 is set to be lower than the temperature of the second coolant in the rear radiator 200 in the above-described embodiments. However, the magnitude relation of the temperature between the first and second coolant may be reversed.

The first radiator 100 is used as the cross-flow radiator, and the second radiator is used as the down-flow radiator in the above-described embodiments. Alternatively, the first radiator 100 may be used as the down-flow radiator, and the second radiator may be used as the cross-flow radiator.

In the above description, the largest flow amount of the second coolant in the second tubes 211 of the second radiator 200 may be set to be from 1.3 to 1.5 times higher than the average flow amount of the second coolant flowing in the second tubes 211. However, the largest flow amount is not limited to this, and may be set depending on use conditions of each radiator 100, 200.

Additional advantages and modifications will readily occur to those skilled in the art. The disclosure in its broader terms is therefore not limited to the specific details, representative apparatus, and illustrative examples shown and described.

What is claimed is:

1. A cooling device for a vehicle, which cools a first coolant circulating in a first heat generator in a liquid state, and cools a second coolant circulating in a second heat generator, the cooling device comprising:
a first radiator including a plurality of first tubes through which the first coolant flows, the first radiator being configured to cool the first coolant via heat exchange with cooling air, the first tubes being arranged to have a laminated structure; and
a second radiator including a plurality of second tubes through which the second coolant flows, the second radiator being configured to cool the second coolant via heat exchange with the cooling air, the second tubes being arranged to have a laminated structure, wherein
the second radiator is arranged downstream of the first radiator in a flow direction of the cooling air to be overlapped with the first radiator in the flow direction of the cooling air,
the second tubes are elongated in a longitudinal direction different from a longitudinal direction of the first tubes, and
the second radiator is configured to cause a flow amount of the second coolant flowing respectively in the second tubes to be gradually increased with respect to a flow direction of the first coolant flowing in the first tubes.

2. The cooling device according to claim 1, wherein
the first coolant flowing in the first tubes is smaller than the second coolant flowing in the second tubes in total flow amount.

3. The cooling device according to claim 1, wherein
the first coolant is lower than the second coolant in temperature.

4. The cooling device according to claim 1, wherein
the longitudinal direction of the first tubes is parallel to a horizontal direction, and
the longitudinal direction of the second tubes is parallel to a vertical direction.

5. The cooling device according to claim 1, wherein
the first radiator is configured to let the first coolant flow through the first tubes from one end side to the other end side of the first radiator in the longitudinal direction of the first tubes.

6. The cooling device according to claim 1, wherein
the first tubes are separated into a plurality of tube groups, and
the first radiator is configured to let the first coolant flow through the first tubes from one end side to the other end side of the first radiator in the longitudinal direction of the first tubes in at least one of the tube groups, and to let the first coolant flow through the first tubes from the other end side to the one end side of the first radiator in the longitudinal direction of the first tubes in the other tube groups.

7. The cooling device according to claim 1, wherein
the second radiator includes an inlet-side tank extending in a laminated direction of the second tubes,
the inlet-side tank is connected to one end sides of the second tubes in the longitudinal direction of the second tubes to distribute the second coolant to the second tubes,
the inlet-side tank has an end portion in a longitudinal direction of the inlet-side tank at a position corresponding to an upstream side in the flow direction of the first coolant flowing in the first tubes, and
the end portion of the inlet-side tank has an inlet portion through which the second coolant is introduced into the inlet-side tank.

8. The cooling device according to claim 1, wherein
the second radiator includes an inlet-side tank extending in a laminated direction of the second tubes,
the inlet-side tank is connected to one end sides of the second tubes in the longitudinal direction of the second tubes to distribute the second coolant to the second tubes,
the inlet-side tank has an inlet portion through which the second coolant is introduced into the inlet-side tank, and
the inlet portion is located in the inlet-side tank at a position corresponding to a downstream side in the flow direction of the first coolant flowing in the first tubes.

9. The cooling device according to claim 8, wherein
the second radiator includes an outlet-side tank extending in the laminated direction of the second tubes,
the outlet-side tank is connected to the other end sides of the second tubes in the longitudinal direction of the second tubes to receive the second coolant from the second tubes,
the outlet-side tank has an outlet portion through which the second coolant flows out of the outlet-side tank, and
the outlet portion is located in the outlet-side tank at a position corresponding to the downstream side in the flow direction of the first coolant flowing in the first tubes.

10. The cooling device according to claim 1, wherein
the second radiator includes an inlet-side tank extending in a laminated direction of the second tubes,
the inlet-side tank is connected to one end sides of the second tubes in the longitudinal direction of the second tubes to distribute the second coolant to the second tubes, and
the inlet-side tank is configured to cause a flow resistance in the inlet-side tank to be gradually decreased with respect to the flow direction of the first coolant flowing in the first tubes.

11. The cooling device according to claim 1, wherein
the second radiator includes an inlet-side tank extending in a laminated direction of the second tubes,
the inlet-side tank is connected to one end sides of the second tubes in the longitudinal direction of the second tubes to distribute the second coolant to the second tubes,
the inlet-side tank has two inlet portions, through which the second coolant is introduced into the inlet-side tank,
one of the tow inlet portions is located at a predetermined position of the inlet-side tank, and
the other one of the two inlet portions is located in the inlet-side tank at a position corresponding to a downstream side in the flow direction of the first coolant flowing in the first tubes.

12. The cooling device according to claim 11, wherein
the second radiator includes an outlet-side tank extending in the laminated direction of the second tubes,
the outlet-side tank is connected to the other end sides of the second tubes in the longitudinal direction of the second tubes to receive the second coolant from the second tubes,
the outlet-side tank has two outlet portions through which the second coolant flows out of the outlet-side tank,
one of the two outlet portions is located at a predetermined position of the outlet-side tank, and
the other one of the two outlet portions is located in the outlet-side tank at a position corresponding to the downstream side in the flow direction of the first coolant flowing in the first tubes.

13. The cooling device according to claim 1, wherein
the second radiator includes an inlet-side tank extending in a laminated direction of the second tubes,
one end sides of the second tubes in the longitudinal direction thereof are inserted into the inlet-side tank to have inserted lengths, so that the inlet-side tank is connected to the one end sides of the second tubes to distribute the second coolant to the second tubes, and
the inserted lengths of the second tubes are gradually decreased, with respect to the flow direction of the first coolant flowing in the first tubes.

14. The cooling device according to claim 1, wherein
the second radiator includes an inlet-side tank extending in a laminated direction of the second tubes,
one end sides of the second tubes in the longitudinal direction thereof are inserted into the inlet-side tank, so that the inlet-side tank is connected to the one end sides of the second tubes in the longitudinal direction of the second tubes to distribute the second coolant to the second tubes,
a portion of each second tube inserted into the inlet-side tank is expanded in cross-section in the inlet-side tank, and
the second tubes have cross-sections which are gradually increased, with respect to the flow direction of the first coolant flowing in the first tubes.

15. The cooling device according to claim 1, wherein
the second tubes have cross-sections which are gradually increased, with respect to the flow direction of the first coolant flowing in the first tubes.

16. The cooling device according to claim 1, wherein
the second tubes are arranged to have a gap between adjacent two second tubes, the gap being gradually decreased with respect to the flow direction of the first coolant flowing in the first tubes.

17. The cooling device according to claim 1, wherein
the second radiator is configured to have a largest flow amount of the second coolant in the second tubes and an average flow amount of the second coolant in the second tubes, and
a ratio of the largest flow amount to the average flow amount is a range from 1.3 to 1.5.
